(19) United States
(12) Patent Application Publication
(10) Pub. No.: US 2014/0321480 A1
(43) Pub. Date: Oct. 30, 2014

(54) NAMED DATA NETWORKING IN LOCAL AREA NETWORKS

(71) Applicant: QUALCOMM Incorporated, San Diego, CA (US)

(72) Inventors: Qi Xue, San Diego, CA (US); Peerapol Tinnakornsrisuphap, San Diego, CA (US); Bibhu Prasad Mohanty, San Diego, CA (US)

(73) Assignee: QUALCOMM Incorporated, San Diego, CA (US)

(21) Appl. No.: 14/249,025

(22) Filed: Apr. 9, 2014

Related U.S. Application Data
(60) Provisional application No. 61/815,862, filed on Apr. 25, 2013.

(51) Int. Cl. H04L 29/12

(52) U.S. Cl. CPC H04L 61/3015
USPC 370/475

(57) ABSTRACT

A named data networking (NDN) architecture may be implemented within a local area network. A local area networking naming convention may be used in relation to named content from a variety of NDN-enabled devices. A network node (such as an NDN gateway or NDN bridge) may manage the local area networking naming convention and assign a name for the named content of the NDN-enabled device. A network-assigned name in accordance with a local area networking naming convention may be used for group control of multiple NDN-enabled devices. An NDN gateway may be used for translating NDN protocol layer communication to an IP network protocol layer. An NDN bridge may be used for bridging NDN protocol layer communication between various different segments of a local area network. NDN-enabled devices may benefit from longer sleep cycles based upon NDN content caching implemented in the local area network.

### CROSS-REFERENCE TO RELATED APPLICATIONS

This application claims the priority benefit of U.S. Provisional Patent Application Ser. No. 61/815,862, filed Apr. 25, 2013, which is incorporated herein by reference.

### BACKGROUND

Embodiments generally relate to the field of networking, and, more particularly, to named data networking

As content-based applications become more widely deployed, technologies for managing content distribution continue to evolve. For example, communication networks may include connected “everyday” devices that were previously not included in traditional communication networks. These devices may be application-specific devices such as appliances, lighting fixtures, sensors, actuators, home automation controls, and the like in a home networking environment and may operate as part of an “Internet of things” (sometimes also referred to as “Internet of Everything,” or “IoE”).

Named data networking (NDN, and sometimes referred to as content-centric networking, content-based networking, data-oriented networking or information-centric networking) is a networking architecture in which content is requested and shared as “named content” rather than having a specific routable address for the content. For example, in NDN technology, named content is distributed, routed, and cached based on a reference to the content rather than an Internet Protocol (IP) address or source location. Improvements to NDN technology can improve interoperability and coordination between NDN enabled devices.

### SUMMARY

Various embodiments are disclosed for implementing named data networking (NDN) in a local area network environment, such as a home network. NDN-enabled devices may utilize a coordinated local area network naming convention managed by a network node. In one embodiment, an NDN protocol layer may be implemented in a network node and/or an NDN-enabled device for the distribution of named content from the NDN-enabled device. The NDN protocol layer may also be implemented in enhanced network nodes (such as gateways and/or bridges) to coordinate distribution of named content. The named data network architecture may be used in a home network environment to support deployment and operation of NDN-enabled devices.

In one embodiment, a first device may send, to a network node, a request for a name to associate with local data of the first device. The name is received from the network node, wherein the name is in accordance with a local area network naming convention managed by the network node. The first device may generate named content based at least in part on the local data of the first device and the name, and communicate the named content to at least one named data networking-enabled device in the local area network. The named content may be communicated via a named data networking protocol layer to at least one NDN-enabled device in the local area network.

In one embodiment, a local area network naming convention may be managed for named content in a local area network. A network node may receive a request for a name to associate with local data of a first device in the local area network. The network node may provide the name to the first device, wherein the name is in accordance with a local area network naming convention managed by the network node. The network node may receive named content from the first device, the named content based at least in part on the local data of the first device and the name. In one implementation, the named content may be cached by the network node. The network node may receive a request for the named content, wherein the request indicates the name associated with named content. The network node may send the cached named content in response to receiving the request.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example local area network having named data networking implemented in accordance with at least one embodiment of this disclosure.

FIG. 2 depicts an example NDN bridge device in accordance with at least one embodiment of this disclosure.

FIG. 3 depicts an example NDN gateway device in accordance with at least one embodiment of this disclosure.

FIG. 4 depicts a message flow in an IP-based architecture for communicating with an NDN-enabled device.

FIG. 5 depicts an example message flow in a mixed local area network having an NDN gateway in accordance with at least one embodiment of this disclosure.

FIG. 6 depicts an example message flow in an NDN-based local area network with a plurality of NDN-enabled devices in accordance with at least one embodiment of this disclosure.

FIG. 7 depicts a plurality of protocol stacks having an NDN protocol layer in accordance with various embodiments of this disclosure.

FIG. 8 depicts a plurality of protocol stacks including a protocol stack for an NDN gateway in accordance with at least one embodiment of this disclosure.

FIG. 9 depicts an example message flow with data aggregation in an NDN-based local area network in accordance with at least one embodiment of this disclosure.

FIG. 10 depicts an example message flow with data aggregation in a mixed local area network in accordance with at least one embodiment of this disclosure.

FIG. 11 depicts an example message flow with a group control message in accordance with at least one embodiment of this disclosure.

FIG. 12 depicts an example message flow with a control message in a mixed local area network in accordance with at least one embodiment of this disclosure.

FIG. 13 depicts another example message flow with a control message in a mixed local area network in accordance with at least one embodiment of this disclosure.

FIG. 14A depicts a flow diagram for an NDN-enabled device to share named content in accordance with at least one embodiment of this disclosure.

FIG. 14B depicts a flow diagram for a network node capable of caching named content in accordance with at least one embodiment of this disclosure.

FIG. 14C depicts a flow diagram for a first device to obtain a name for named content in accordance with at least one embodiment of this disclosure.

FIG. 14D depicts a flow diagram for a network node to provide a name for named content in accordance with at least one embodiment of this disclosure.

FIG. 15 depicts a system diagram for implementing a named data networking protocol layer in accordance with at least one embodiment of this disclosure.

### DESCRIPTION OF EMBODIMENT(S)

The description that follows includes exemplary systems, methods, techniques, instruction sequences and computer program products that embody the present subject matter. However, the described embodiments may be practiced without these specific details. For instance, although examples may refer to particular types of devices, such as lighting controls or sensors, various embodiments of this disclosure are applicable to a wide variety of devices which may be implemented in a home networking environment. Furthermore, the disclosure is not limited to home networking environments for a residential home, but may also be applicable to other types of business or residential networks, including a variety of building automation system architectures. Additionally, the embodiments described in this disclosure may be applicable to other small-scale networks or local area networks in which NDN-enabled devices may be coupled. In some instances, well-known instruction instances, protocols, structures and techniques have not been shown in detail in order not to obfuscate the description.

Local area networks may comprise one or more networking technologies (e.g., various combinations that may include, without limitation, wireless local area network (WLAN) technologies, powerline communication (PLC) technologies, multimedia over coaxial (MoCA), IEEE 1901, Ethernet, etc.). Typically, the communication mechanisms and protocol specifics (e.g., device and topology discovery protocols, bridging protocols, etc.) are unique to each networking technology. An example of a local area network is a home communication network. In some embodiments, a home communication network may also be referred to as a hybrid communication network, home environment network, mixed communication network, connected home, or simply a “home network.”

Traditionally, local area networks have relied upon Internet Protocol (IP) as a common protocol to coordinate communication involving various lower layer protocols. However, IP protocols may require more communication overhead than is desirable for particular devices. For example, a sensor or actuator coupled to a local area network may be unnecessarily burdened by implementing address resolution protocol (ARP), TCP/IP protocol stack, or an application layer protocol such as HTTP. Furthermore, service discovery and content distribution techniques that rely on traditional IP may require a device to remain active to monitor traffic in a local area network. For some devices, it may be desirable to limit communication activity and provide for longer periods of inactivity.

In this disclosure, named data networking (NDN) architecture may be implemented within a local area network, such as a home network or other small-scale network. An NDN-enabled device may implement an NDN protocol layer as part of a network interface protocol stack. Examples of NDN-enabled devices may include network nodes (such as routers, servers, gateways and bridge devices) and Internet of Everything (IoE) devices. In some embodiments, NDN-enabled devices are application-specific devices (such as sensors, controllers, actuators, etc.) and may have limited computing and communication capability. In some embodiments of this disclosure, a network node may be considered application-agnostic or may support multiple applications associated with a variety of NDN-enabled devices.

The NDN architecture may co-exist with IP-based devices in a local area network. An NDN-enabled device may or may not implement IP protocols. NDN capable networks may provide increased interoperability, mobility of devices, cost effectiveness for NDN-enabled devices, reduced power consumption, and/or improvements to content distribution and control in a local area network. For example, in some embodiments, an NDN-enabled device may be battery operated and ideally utilizes less frequent network communication to reduce power consumption. Network nodes may be powerline powered and may provide content caching for named content provided by an NDN-enabled device. In some embodiments, a first NDN-enabled device (such as a network node) may also cache named content provided by a second NDN-enabled device.

In one embodiment, methods and apparatus are disclosed in which an NDN protocol layer of an NDN-enabled device is capable of communicating named content via a physical network interface to at least one network node in a local area network. In some implementations, the NDN protocol layer may utilize a media access control (MAC) protocol layer to communicate via a local area network.

In another embodiment, methods and apparatus for a network node are disclosed. A network node is an NDN-enabled device that provides for coordination and/or management of named content in a local area network. For example, the network node may comprise an NDN gateway for translating NDN protocol layer communication to an IP network protocol layer. Alternatively, the network node may comprise an NDN bridge for bridging NDN protocol layer communication between various different segments of a local area network. In one implementation, an NDN protocol layer of the network node may be capable of receiving named content via a physical network interface from at least one NDN-enabled device in the local area network and associating the named content with a logical name associated with the NDN-enabled device. The network node may be involved in assignment of names to the local data of various NDN-enabled devices in the local area network. The network node may also provide for the coordination of command messages to various NDN-enabled devices or the aggregation of data from various NDN-enabled devices.

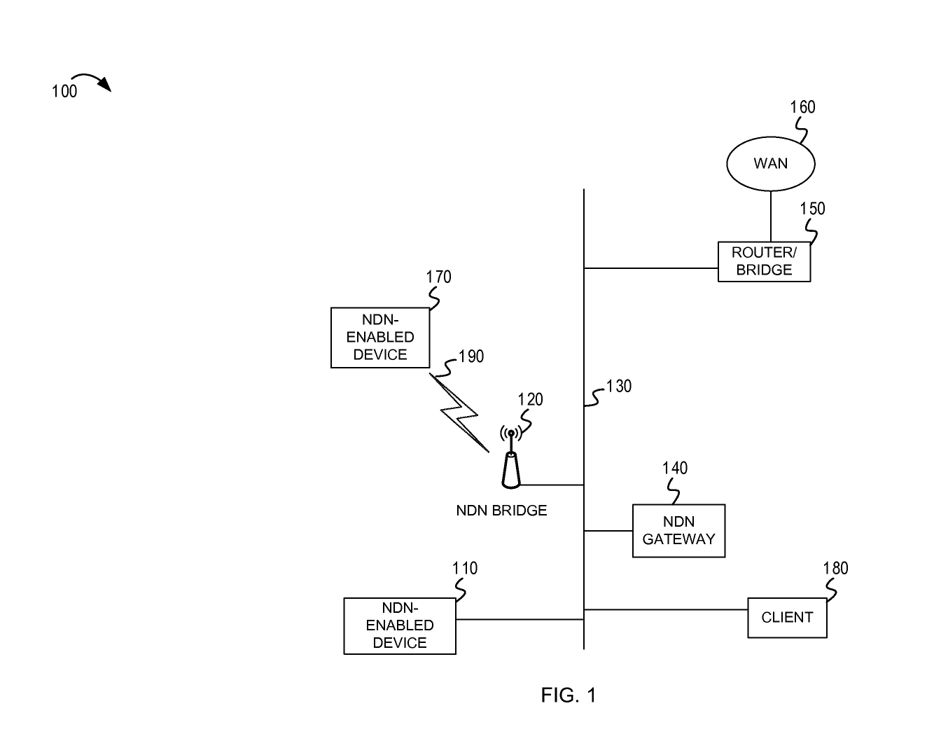

FIG. 1 illustrates an example local area network 100 to introduce various concepts associated with this disclosure. The example local area network 100 includes a first NDN-enabled device 110 in which an NDN protocol layer may be implemented. The first NDN-enabled device 110 may be communicatively coupled to a first segment (also referred to as “portion”) 130 of the local area network 100. For example, the first segment 130 may be of any type of wireline or wireless network medium, such as those commonly used in local area networks. In the example local area network 100, the first segment 130 may comprise an Ethernet-based communication medium.

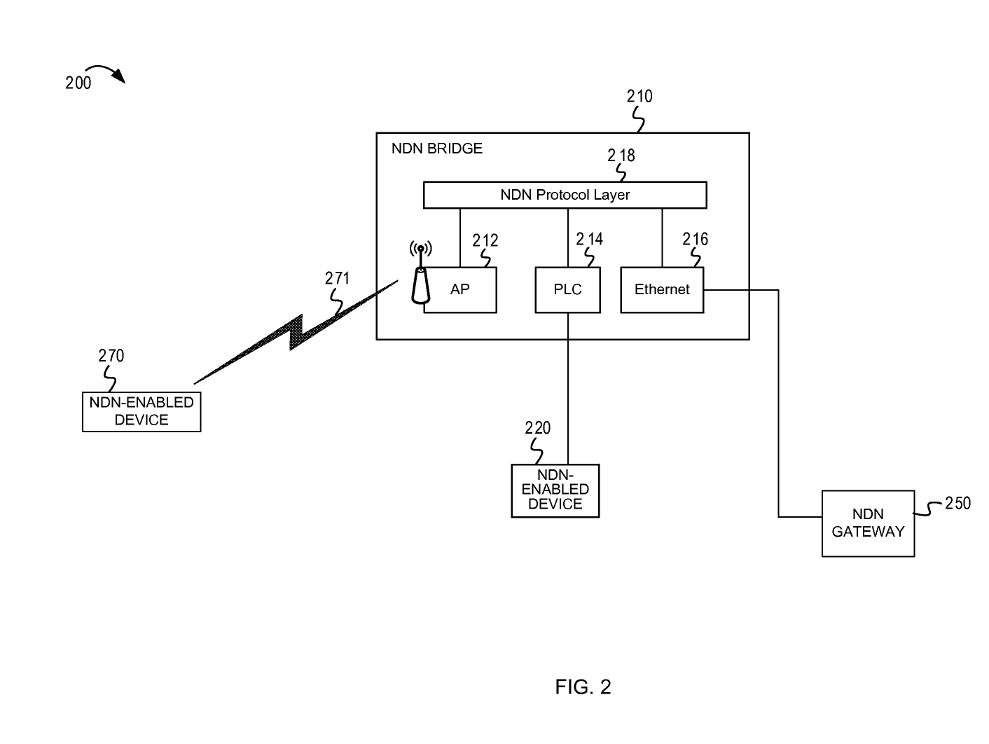

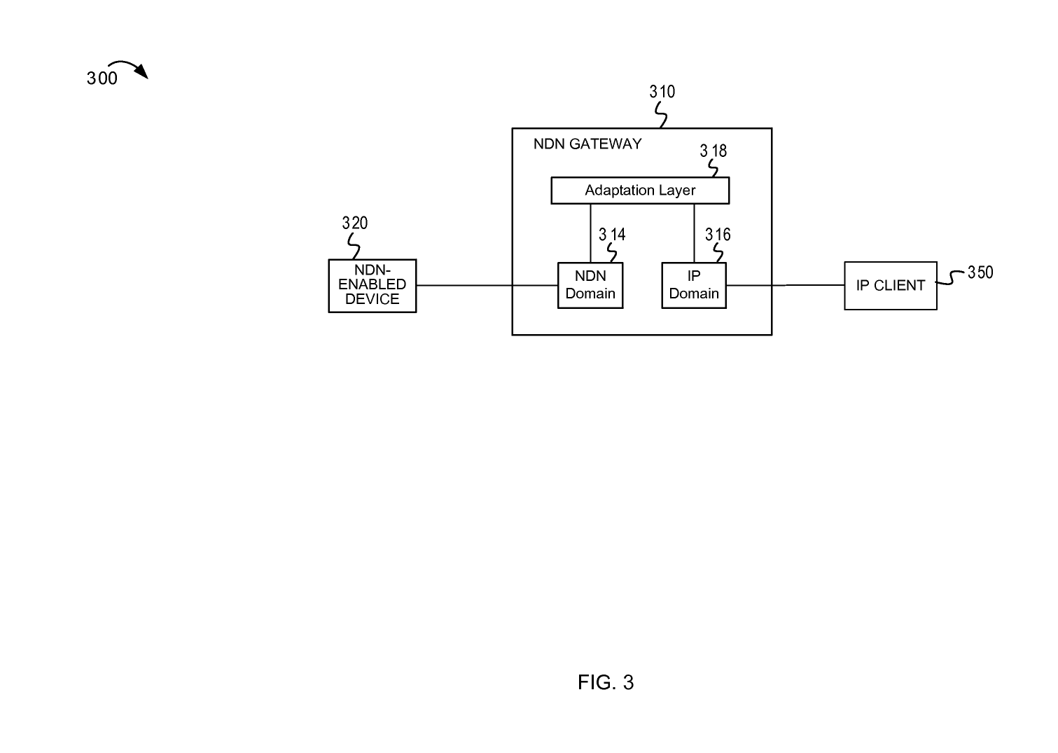

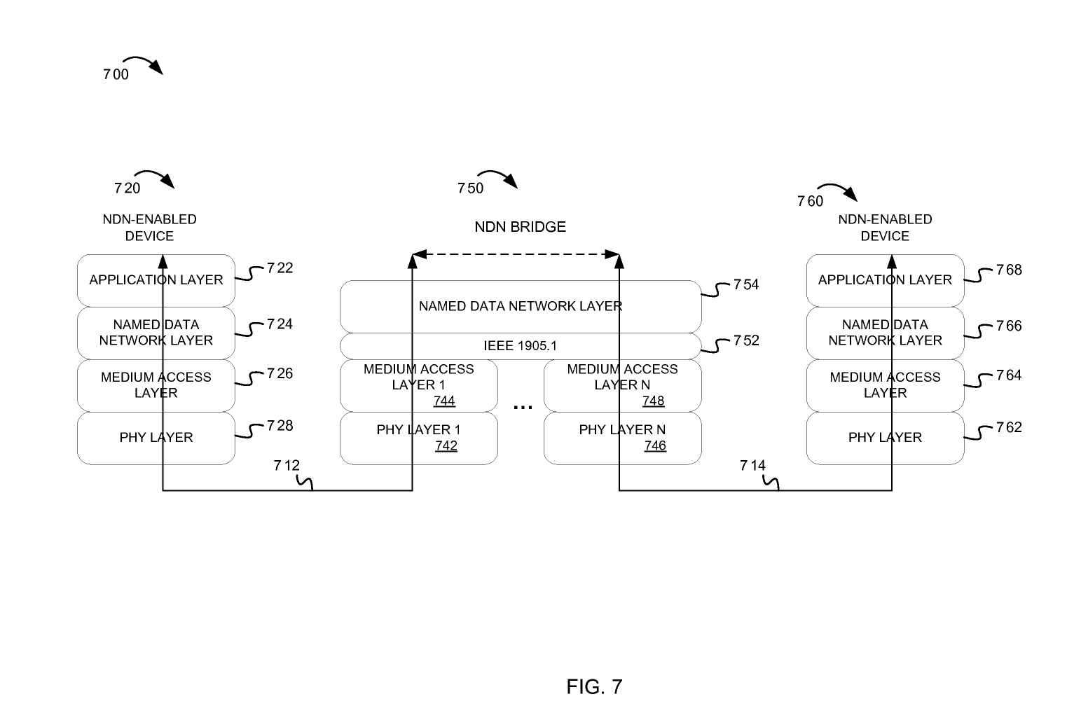

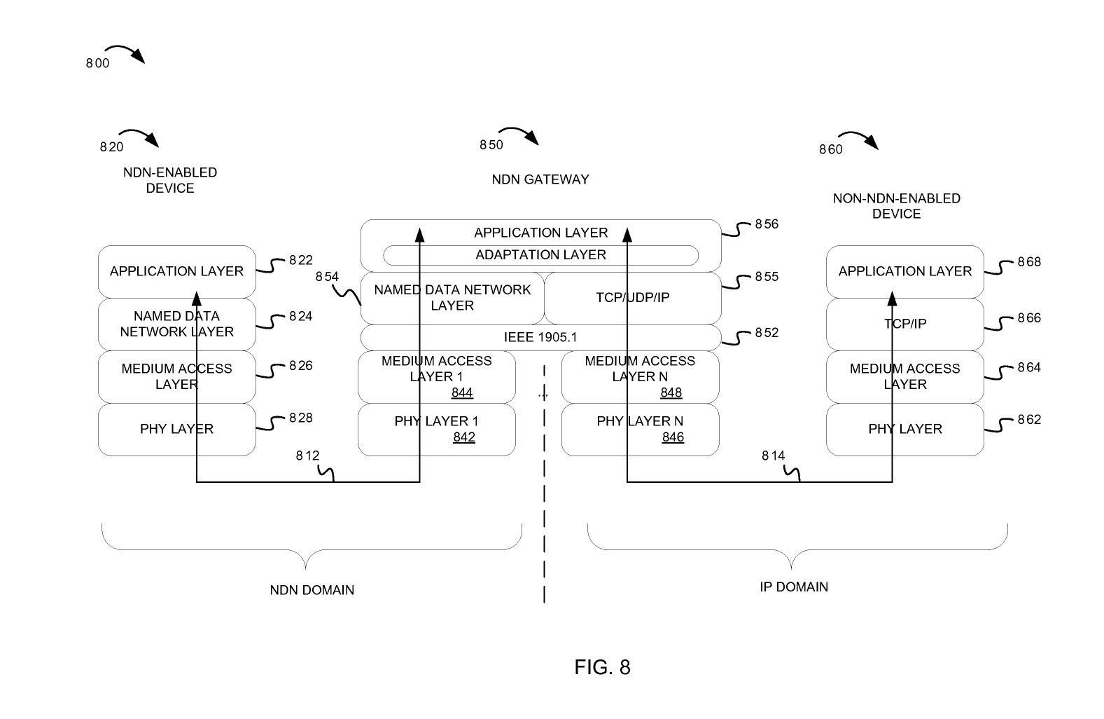

Also coupled to the first segment 130 are a client device 180, an NDN gateway 140, a router/bridge 150 and an NDN bridge 120. NDN bridge devices are devices that implement an NDN protocol layer and bridge two different network segments. NDN gateway devices are devices that implement an NDN protocol layer and provide an adaptation mechanism to coordinate traffic between the NDN protocol and another network protocol, such as IP. NDN bridge devices are described in more detail in FIGS. 2 and 7. NDN gateway devices are described in more detail in FIGS. 3 and 8. Each of the NDN gateway 140, router/bridge 150 and NDN bridge 120 may perform the functionality of a network node as described herein. Other types of network nodes (not shown) may include a server, a computer, or another NDN-enabled device configured as a network node.

In the example local area network 100, the NDN bridge 120 includes a wireless access point which provides a wireless communication link 190 to a second NDN-enabled device 170. The first NDN-enabled device 110 and second NDN-enabled device 170 may communicate with each other using the NDN bridge 120 via the first segment 130 and the wireless communication link 190 (i.e., the wireless communication may comprise a second segment of the example local area network 100).

A router/bridge 150 may provide access to a wide area network (WAN) 160, such as the Internet. In some implementations the router/bridge 150 may be implemented in the same device as either the NDN gateway 140 or the NDN bridge 120.

NDN protocol traffic may coexist with IP network protocol traffic on the same network segment or communication medium. In some example embodiments, a MAC layer protocol is used to coordinate layer 2 (referencing the Open Systems Interconnect, OSI, protocol layer model) traffic on a communication medium. The NDN protocol layer may be used at layer 3 of the protocol stack and communicate directly using MAC transmissions without the use of another network protocol layer (such as IP). However, IP traffic and NDN traffic may share the network segment.

The first NDN-enabled device 110 may communicate named content using the NDN protocol layer. The names used for various content items may conform to a local area network naming convention. For example, an initial namespace may be based on manufacture of the device or type of the device. In some embodiments, the naming schema may be standardized to allow for interoperability of NDN-enabled devices from different manufacturers. A network node may be configured to provide a name to the NDN-enabled devices responsive to a request from the NDN-enabled devices. The network node may assign a name in accordance with a local area network naming convention managed by the network node. For example, the name may include a topological root name, followed by a device type and location indicator. As an example of a name for named content in which the first NDN-enabled device 110 is a lighting fixture in the master bedroom, the named content may be identified by the name “/home/lighting/masterbedroom.” It is noted that the names used in this disclosure are merely example and are not intended to limit the scope of the disclosure. In some embodiments, the names for various content blocks are preconfigured in the device. In other embodiments, the device may be configured with default initial names for content items and update the names for content items upon being activated in the local area network.

As the first NDN-enabled device 110 communicates the named content, a network node (such as the NDN gateway 140 and/or the NDN bridge 120) may cache copies of the content. Whenever a request for a content item is requested, the network node may determine whether a cached copy is available and respond to the request with the cached copy of the named content. For example, if the client device 180 requests named content from the NDN gateway 140, the NDN gateway may retrieve the named content from the first NDN-enabled device 110 or from local cache memory of the NDN gateway 140 (if the named content has been previously received and cached by the NDN gateway 140). In some embodiments, named content may be associated with a timestamp or expiration value which is used by the network node to maintain the content item in local cache. Upon expiration or upon determining that the timestamp is old enough to consider the cached content as being stale, the network node may remove the cached content from the local memory.

A network node may coordinate NDN traffic between different segments of the local area network. For example, the NDN bridge 120 may maintain an awareness of the underlying physical network interface or network segment and next hop MAC address associated with various NDN-enabled devices 110, 170 on the segment. The NDN bridge 120 may also provide a mapping of logical NDN interfaces, for instance the links from a local physical network interface to various NDN-enabled devices 110, 170, to named contents. For example, the network node may determine that named content received from first NDN-enabled device 110 was received via a particular ingress interface of a first segment 130. Whenever a message for a named content is received, the NDN bridge 120 may be configured to forward the message via the appropriate egress interface for the first segment 130. In some embodiments, the NDN interface may provide a mapping to the named content for other NDN-enabled devices to connect to the application from a particular segment of the network. The NDN bridge 120 may act as a proxy representing the second NDN-enabled device 170 on the first segment 130.

A network node (such as the NDN gateway 140) may coordinate between the NDN network protocol and the IP network protocol. For example, this may allow for interoperability between IP enabled devices to communicate with NDN enabled devices. The NDN gateway 140 may implement appropriate protocol stacks and adaptation techniques to coordinate between the two network protocols. Examples may include translating requests for an IP based resource (such as a uniform resource locator, URL, a uniform resource indicator, URI, or an IP address) into a name associated with named content. In some embodiments, the NDN gateway 140 may include a web services (e.g., hypertext transfer protocol, HTTP) as a server front-end to the NDN network protocol. In some embodiments, the NDN gateway 140 may also provide IP-based access from the WAN 160 to named content associated with the NDN-based local area network. The network node may provide remote access to a machine via a wide area network. The machine may use the remote access to obtain, via the network node, the named content located in the local area network. The named content may be associated with a first name associated in accordance with a local area network naming convention and also associated with a second name in accordance with a public network naming convention. The network node may translate names associated with the public network naming convention to the corresponding names associated with the local area network naming convention. Examples of names associated with the public network naming convention may include a URI, a resource name associated with web service, an IP address and/or port number, a hostname, and a web address domain name.

Many more example features and embodiments for using NDN-based protocol communication in a local area network will be made apparent through the following figures and supporting description.

FIG. 2 is an illustration of an example system 200 that includes an example NDN bridge 210 in accordance with at least one embodiment of this disclosure. The NDN bridge 210 includes a plurality of physical network interfaces, including a wireless local area network (WLAN) interface 212, a powerline communication (PLC) interface 214, and an Ethernet interface 216. The NDN bridge 210 also includes an NDN protocol layer 218 which is communicatively coupled to the plurality of physical network interfaces 212, 214 and 216. Although the NDN protocol layer 218 is depicted as a single instance, in some embodiments the NDN protocol layer may be implemented as a plurality of NDN protocol layers or modules.

In the example system 200, the WLAN interface 212 is providing a wireless communication link 271 to a first NDN-enabled device 270. The PLC interface 214 is communicatively coupled to a second NDN-enabled device 220. The NDN protocol layer 218 provides a bridging service so that the first NDN-enabled device 270 and the second NDN-enabled device 220 may communicate with each other using the NDN protocol even though they are each using different communication medium to the NDN bridge 210. The NDN bridge 210 may also bridge NDN traffic via the Ethernet interface 216 to an NDN gateway 250.

In some implementations, the NDN bridge 210 and NDN gateway 250 may be collocated in the same machine or may be implemented as a single network node.

FIG. 3 is an illustration of a system 300 that includes an example NDN gateway 310 in accordance with at least one embodiment of this disclosure. The NDN gateway 310 includes protocols associated with the NDN domain 314. For example, the NDN gateway 310 may implement an NDN protocol layer as part of the NDN domain 314. The NDN protocol layer (part of NDN domain 314) is capable of communicating with other NDN-enabled devices in the local area network, such as NDN-enabled device 320.

The NDN gateway 310 also implements protocols associated with the IP domain 316, including an IP layer. The IP layer (part of the IP domain 316) is capable of communicating with other IP-enabled devices in the local area network, such as IP client 350 or an application server (not shown). The NDN gateway 310 also includes an adaptation layer 318 that provides protocol and data adaptation between the NDN domain 314 and the IP domain 316. For example, the adaptation layer 318 may be used to map domain name service (DNS) records for DNS-SD (DNS Service Delivery protocol) to NDN content names.

In some implementations, the NDN gateway 310 may also be used to regulate the NDN naming scheme used in the local area network. NDN-enabled devices may register to the NDN domain 314 via the NDN gateway 310 and receive an assigned name hierarchy from the NDN gateway 310. For example, an NDN-enabled device 320 may communicate a request to the NDN gateway 310 to request a name to associate with local data of the NDN-enabled device 320. The NDN-enabled device 320 may receive, from the NDN gateway 310, a name in accordance with a local area network naming convention managed by the NDN gateway 310. The NDN-enabled device 320 may then use the assigned name when generating named content from the local data of the NDN-enabled device 320. In some implementations, the NDN gateway 310 may assign names to a plurality of NDN-enabled devices based upon a local area network naming convention managed by the NDN gateway 310.

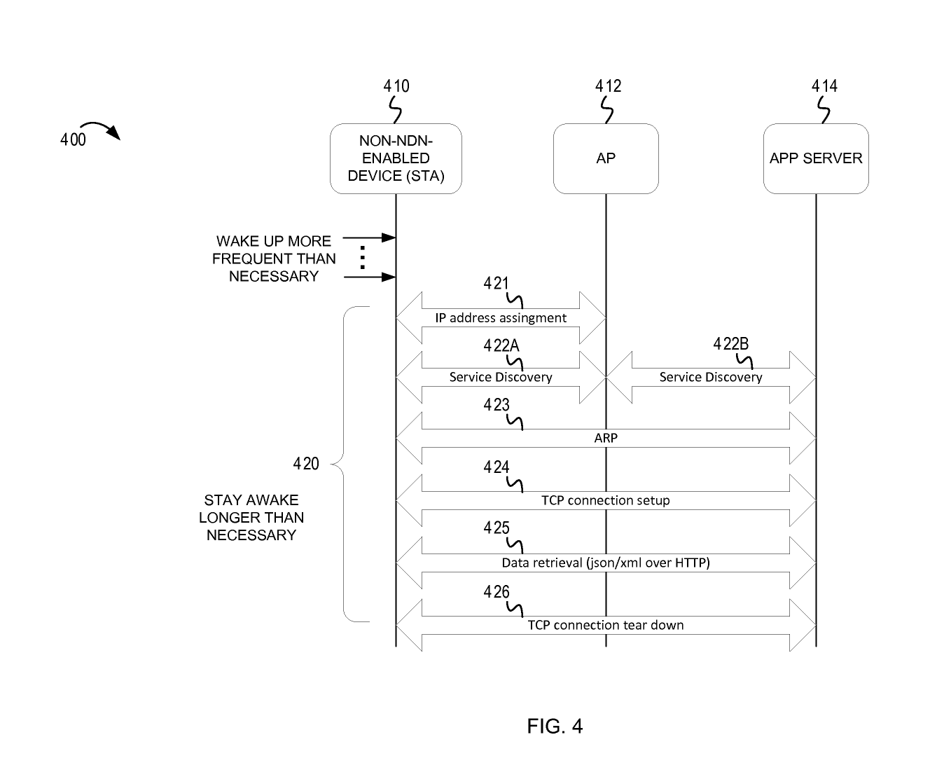

FIG. 4 depicts a message flow 400 in an IP-based architecture for communicating with a non-NDN-enabled device 410. The non-NDN-enabled device 410 is a wireless enabled device acting as a wireless station (STA) in the WLAN. The non-NDN-enabled device 410 may be communicatively coupled to an access point (AP) 412. An application server 414 may also be communicatively coupled to the AP 412. In traditional IP based architectures, the non-NDN-enabled device 410 may obtain an assigned IP address 421 from the AP 412. A service discovery protocol 422A, 422B may be used for the application server 414 to discover the presence of the non-NDN-enabled device 410 in the local area network. Examples of the service discovery protocol may include multicast DNS or DNS-SD. To discover location/address information, an address resolution protocol (ARP) 423 may be used between the various devices in the IP based network. Whenever an application communicates with the non-NDN-enabled device 410, a series of additional protocols may be used, including transport control protocol (TCP) connection setup 424, an HTTP application layer protocol exchange 425, and TCP connection tear down 426.

As a result of the TCP/IP overhead associated with the IP based architecture, the non-NDN-enabled device 410 may stay awake (e.g., not idle) 420 for longer periods of time. Moreover, the same process for TCP/IP communication may be repeated by the application server 414 for each of a plurality of non-NDN-enabled device devices in the local area network. An object of this disclosure is to reduce overhead, coordinate content among a plurality of devices, and enable a device to stay dormant (e.g., sleep mode) for longer periods of time.

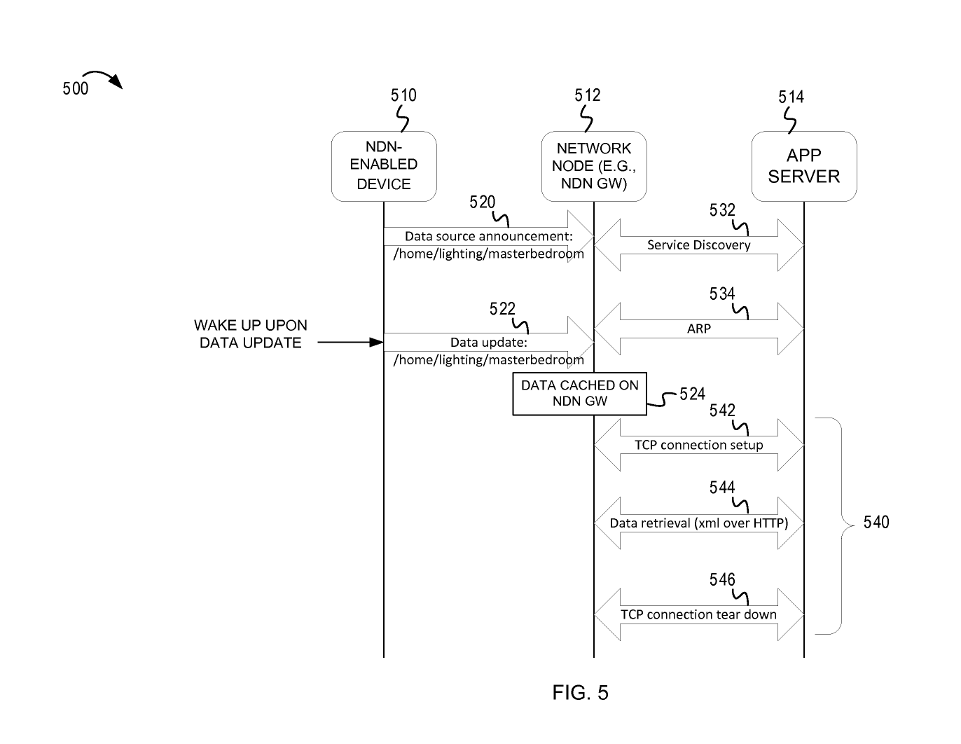

FIG. 5 depicts an example message flow 500 in a mixed local area network having NDN-enabled device 510, a network node 512 (e.g., an NDN gateway), and an application server 514. In FIG. 5, the network node 512 may be similar to the AP 412 in FIG. 4. However, in FIG. 5, the network node 512 implements the NDN protocol layer for communicating with the NDN-enabled device 510. In this example, the NDN-enabled device 510 may be a light sensor or lighting fixture. The NDN-enabled device 510 sends a data source announcement message 520 to the network node 512. The data source announcement message 520 may include named content which is named in accordance to a local area network naming convention. In the example of FIG. 5, the NDN-enabled device 510 provides named content that is associated with the name “/home/lighting/masterbedroom.” For example, the actual content associated with the name may indicate a status of the lights in the master bedroom. Whenever the NDN-enabled device 510 detects a change (e.g., the lights change from on to off, or vice versa), the NDN-enabled device 510 may send a data update message 522 to the network node 512 to provide the updated content associated with the same name.

Shown at 524, the network node 512 may cache the named content in association with the name. For example, the cache memory may include the content (data) stored along with the name and other information included in the data update message 522 or data source announcement 520 messages. Because the NDN-enabled device 510 “wakes up” to send updates to the data, the NDN-enabled device 510 may experience longer periods of inactivity (e.g., sleep mode) between updates.

In the example of FIG. 5, the application server 514 may be an IP-based application server using an IP-based home automation protocol to communicate with an IP portion of the network node 512. The network node 512 includes adaptation information to translate information from the named content into the IP-based home automation protocol. The application server 514 may utilize IP-based protocols and messages to communicate with the network node 512; including service discovery 532, ARP 534, TCP connection setup 542, data retrieval 544, and TCP connection tear down 546 message exchanges. Shown at 540, the application server 514 may obtain the latest device update from the network node 512 because the network node 512 has maintained the named content in cache memory.

In some implementations, the application server 514 may communicate with the network node 512 using messages that would be intended for a NDN-enabled device. For example, the application server 514 may not be aware that the network node 512 is acting as a proxy for the NDN-enabled device 510. The network node 512 may respond to messages that would be exchanged between the NDN-enabled device and the application server 514 on behalf of the NDN-enabled device 510. Having the network node 512 respond to messages on behalf of the NDN-enabled device 510 may reduce communication overhead to the NDN-enabled device 510. In the event that the network node 512 does not have the named content stored in cache memory or the named content is deemed stale due to timestamp or expiration parameters, the network node 512 may translate the request for content into an NDN-based protocol message and forward the NDN-based protocol message to the NDN-enabled device 510.

In the example of FIG. 5, the enhanced NDN-capable devices were introduced into the local area network without causing the non-NDN-enabled devices from becoming immediately obsolete. In the so-called mixed network, the NDN-enabled devices and non-NDN-enabled device may coexist because of the protocol translation provided by the network node 512. Furthermore, in some implementations the application server 514 may be geographically remote from the network node 512. The IP-based communication between the application server 514 and the network node 512 may include IP packets routed via a public IP network, including the Internet. Meanwhile, the network node 512 may communicate efficiently using the NDN protocol to devices in the local area network.

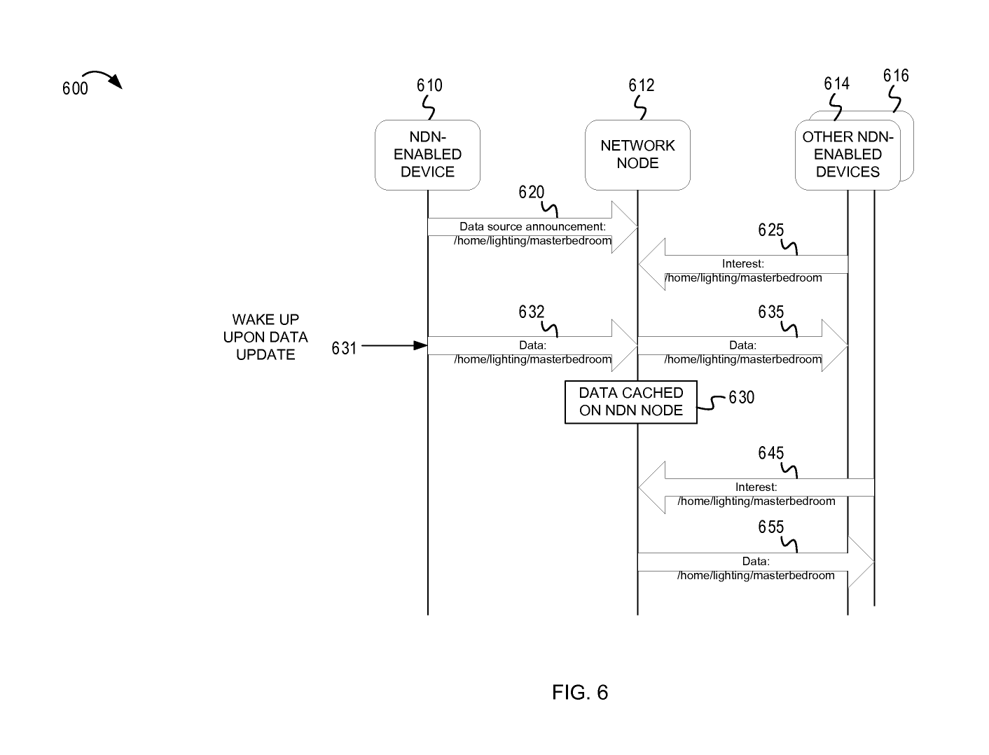

FIG. 6 depicts an example message flow 600 in an NDN-based local area network with a plurality of NDN-enabled devices 610, 612, 614, 616. As described in FIG. 5, the NDN-enabled device 610 may send a data source announcement message 620 to the network node 612 (the network node 612 may be an NDN bridge or NDN gateway). The data source announcement message 620 may include named content (e.g., “/home/lighting/masterbedroom”). In FIG. 6, another NDN-enabled device 614 may express interest in the named content. For example, the NDN-enabled device 614 may send an “interest” message 625 requesting the named content (referencing the name of the named content in the interest message 625). Whenever the NDN-enabled device 610 detects a change 631 (e.g., the lights change from on to off, or vice versa), the NDN-enabled device 610 may send a data update message 632 to the network node 612 to provide the updated content associated with the same name. The network node 612 determines that a pending interest message 625 for the named content has been provided by the NDN-enabled device 614. In response to the interest message 625, the network node 612 sends the named content to the NDN-enabled device 614 in a data message 635.

The network node 612 also cache 630 the named content for subsequent use. For example, when a second NDN-enabled device 616 expresses interest (via interest message 645) in the named content, the network node 612 may respond to the interest by sending the cached named content in a data message 655 without requiring further exchange of messages with the NDN-enabled device 610. Furthermore, in the example of FIG. 6, if the devices are capable of using the NDN protocol, the IP network protocol layer may or may not utilized.

FIG. 7 depicts a plurality of protocol stacks 700 each having an NDN protocol layer in accordance with various embodiments of this disclosure. A first protocol stack is associated with a first NDN-enabled device 720 (such as NDN-enabled device 510, 610). The protocol stack associated with a first NDN-enabled device 720 includes Physical (PHY) interface layer 728, a medium access layer 726 (also referred to as a media access control, MAC, layer), a named data network layer 724, and an application layer 722.

An NDN bridge 750 may implement similar protocols. In some embodiments, the NDN bridge 750 may include a plurality of physical layer interfaces 742, 746. Each physical layer interface 742, 746 may be associated with a different media access layer 744, 748, respectively. The NDN bridge 750 may optionally also have an IEEE 1905.1 layer 752 (also referred to as a MAC abstraction layer) which is used to coordinate communication among the various MAC layers 1-N as well as providing additional networking control protocols. IEEE P1905.1 draft standard defines a MAC abstraction layer (AL) for multiple home network technologies that provides a common interface to several popular network technologies: IEEE 1901 over powerlines, IEEE 802.11 for wireless, Ethernet over twisted pair cable and MoCA 1.1 over coax. The NDN bridge 750 also has a named data network layer 754 which is capable of bridging communications 712, 714 between the first NDN-enabled device 720 and a second NDN-enabled device 760.

In the example of FIG. 7, the protocol stack associated with the second NDN-enabled device 760 is similar to the protocol stack associated with the first NDN-enabled device 720. The protocol stack of the second NDN-enabled device 760 includes a Physical (PHY) interface layer 762, a medium access layer 764, a named data network layer 766, and an application layer 768.

FIG. 8 depicts a plurality of protocol stacks 800 including protocol stacks for a first NDN-enabled device 820, an NDN gateway 850, and a non-NDN-enabled device 860. A first protocol stack is associated with a first NDN-enabled device 820 (similar to NDN-enabled devices 510, 610). The protocol stack associated with a first NDN-enabled device 820 includes PHY interface layer 828, a medium access layer 826, a NDN layer 824, and an application layer 822.

An NDN gateway 850 may implement similar protocols. In some embodiments, the NDN gateway 850 may include a plurality of physical layer interfaces 842, 846. Each physical layer interface 842, 846 may be associated with a different media access layer 844, 848, respectively. The NDN gateway 850 may optionally also have an IEEE 1905.1 layer 852 to coordinate communication among the various MAC layers 1-N. The NDN gateway 850 also has an NDN layer 854 which is capable of communicating using the NDN network protocol with the NDN layer 824 of the first NDN-enabled device 820. The NDN gateway also includes protocols associated with the IP domain, including TCP/UDP/IP protocol layers 855. The NDN gateway 850 may include an application layer 856 with an adaptation layer that can translate between the NDN protocol and the IP-based protocol. In some implementations, the adaptation layer may be implemented separately from an application layer. For example, the adaptation layer may be a one-to-one protocol conversion layer between the NDN layer 854 and the TCP/UDP/IP protocol layer 855.

The application layer 856, if implemented, may provide coordination of the naming scheme used for the local area network. For example, the application layer 856 may include user interface tools to allow an administrator of the local area network to assign a custom naming convention or to view a selected naming convention from a plurality of preconfigured or standardized naming conventions.

In the example of FIG. 8, the protocol stack associated with a non-NDN-enabled device 860 includes a Physical (PHY) interface layer 862, a medium access layer 864, a TCP/IP layer 866, and an application layer 868. Communications 814 from the non-NDN-enabled device 860 are considered to be within the IP domain of the local area network. Communications 812 from the first NDN-enabled device 820 are considered to be within the NDN domain of the local area network. The NDN gateway 850 provides coordination between the NDN domain and the IP domain using the application layer 856 or the adaptation layer.

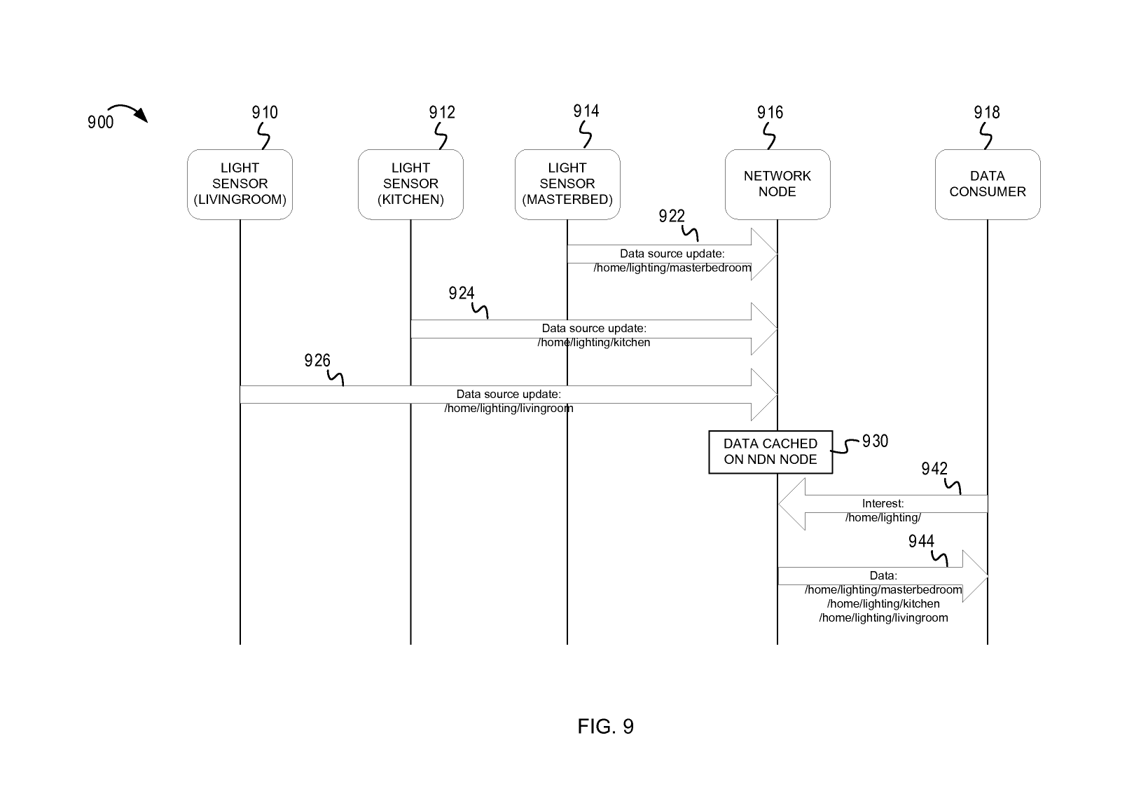

FIG. 9 depicts an example message flow 900 showing data aggregation in an NDN-based local area network. An example local area network includes a light sensor 910 (located in the living room) which has been given the logical name “livingroom.” The full name of the content from light sensor 910 is “/home/lighting/livingroom.” Similarly, the example local area network includes light sensors 912, 914 which are named “kitchen” and “masterbedroom” respectively. The example local area network also includes a network node 916 and a data consumer 918 (e.g., a client device).

In the example message flow 900, the light sensors 914, 912, 910 each sends data source update message 922, 924, 926, respectively, to the network node 916. The named content associated with the data source update message 922 (from light sensor 914) is named “/home/lighting/masterbedroom.” The named content associated with the data source update message 924 (from light sensor 912) is named “/home/lighting/kitchen.” The named content associated with the data source update message 926 (from light sensor 910) is named “/home/lighting/livingroom.” The data from each of the light sensors 910, 912, 914 may be cached 930 locally at the network node 916.

As an example of data aggregation which is possible due to the local area network naming convention, consider a following example. The data consumer 918 may desire a status of multiple lights in the local area network. The data consumer 918 sends an interest message 942 which indicates “/home/lighting/” (or “/home/lighting/*”). The interest message may not specify a particular light sensor, but rather includes a common portion of the names associated with the multiple lights. The network node 916 may use prefix matching to identify the relevant named content. In response to the interest message 942, the network node 916 responds back with a data message 944 that includes the named content of “/home/lighting/masterbedroom,” “/home/lighting/kitchen,” and “/home/lighting/livingroom” since all three items of named content include the name prefix included in the interest message 942.

FIG. 10 depicts an example message flow 1000 with data aggregation in a mixed local area network. Similar to FIG. 9, the example local area network includes light sensors 1010, 1012, 1014, corresponding to similar light sensors 910, 912, 914 described in FIG. 9. Data source update messages 1022, 1024, 1026 include named content from each of the light sensors 1014, 1012, 1010, respectively. The named content is cached 1030 on the network node 1016. An application server 1018 may communicate using an IP based protocol (e.g., TCP setup, data retrieval using HTTP, and TCP teardown messages) to obtain data updates 1040 associated with the light sensors 1010, 1012, 1014. Efficiently, a single TCP/IP protocol exchange may be used for the application server 1018 to obtain an aggregation of the named content for multiple NDN-enabled devices. Furthermore, the NDN-enabled devices (i.e., light sensors 1010, 1012, 1014) provided updates at different times and monitor for separate status messages from the application server 1018.

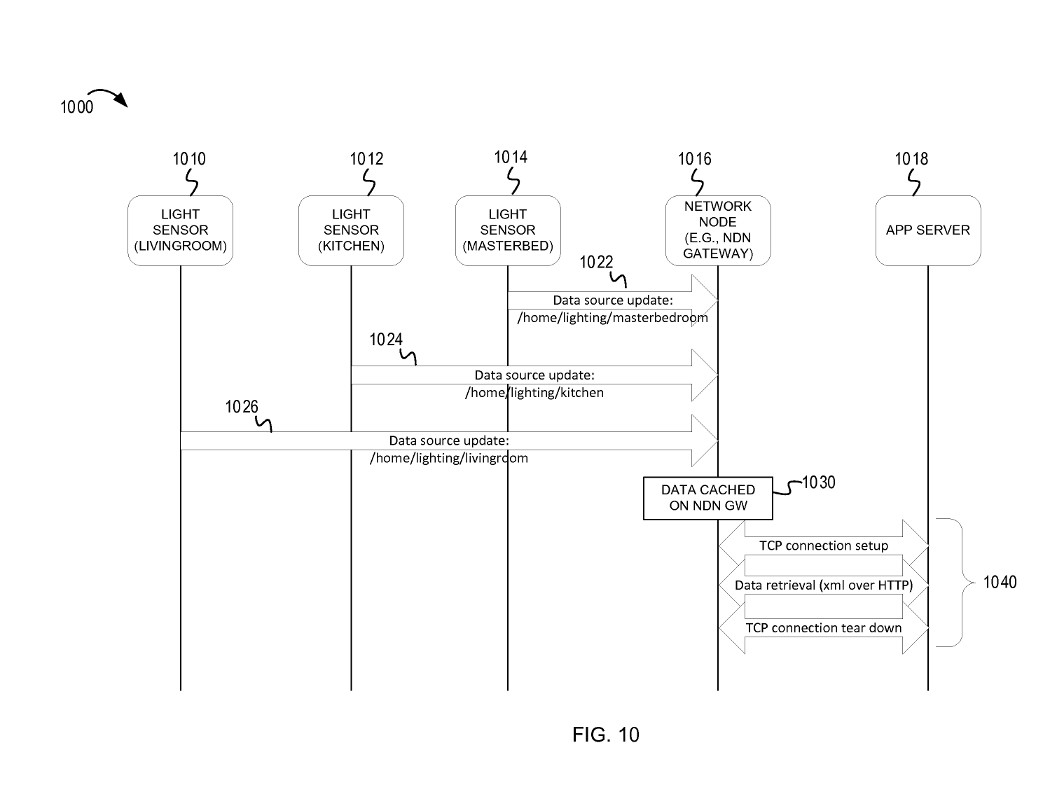

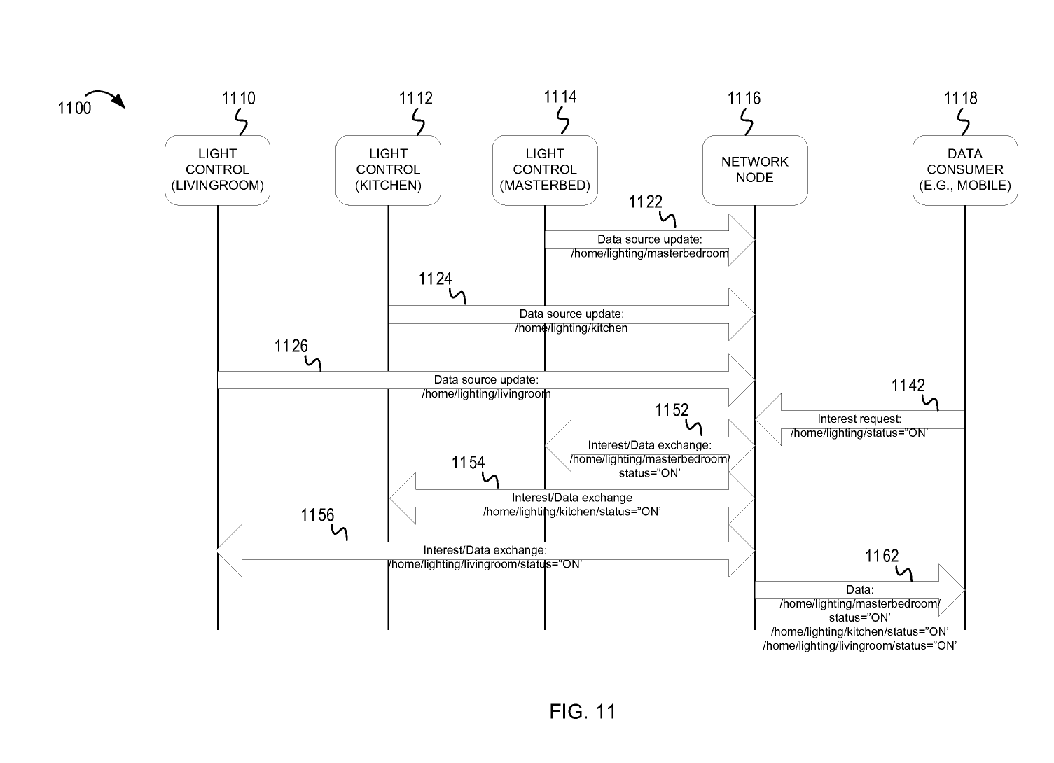

FIG. 11 depicts an example message flow 1100 with a group control message in accordance with at least one embodiment of this disclosure. The example local area network includes light control 1110, 1112, 1114, may be similar to light sensors 910, 912, 914 described in FIG. 9 and light sensors 1010, 1012, 1014 described in FIG. 10. Data source update messages 1122, 1124, 1126 to the network node 1116 include named content from each of the light controls 1114, 1112, 1110, respectively. In FIG. 11, the light controls 1110, 1112, 1114 are also equipped with a controller or actuator to change the state of the lighting in each corresponding location. For example, the light controls may be smart light switches with a controller or actuator and an NDN protocol layer.

In the example scenario in FIG. 11, a data consumer 1118 may be capable of sending a command message using an NDN protocol layer. The data consumer 1118 may send an interest request message 1142 which specifies an instruction to change the status of the “/home/lighting/” items to “ON.” For example, interest request message 1142 may include the instruction “/home/lighting/status=ON.”

The network node 1116 may generate and forward corresponding interest request messages 1156, 1154, 1152 to each light control 1110, 1112, 1114, respectively. As an example, the interest request message 1156 indicates the instruction “/home/lighting/livingroom/status=ON.” In response, the light control 1110 may switch a controller or actuator to turn the lights in the living room on. Once the lights are switched on, the light control 1110 may respond with a data update message indicating the new status and confirming that the lights in the living room are on. The network node 1116 may be configured to collect the data update messages from the light controls and provide an aggregated data message 1162 to the data consumer 1118 as a response to the interest request message 1142.

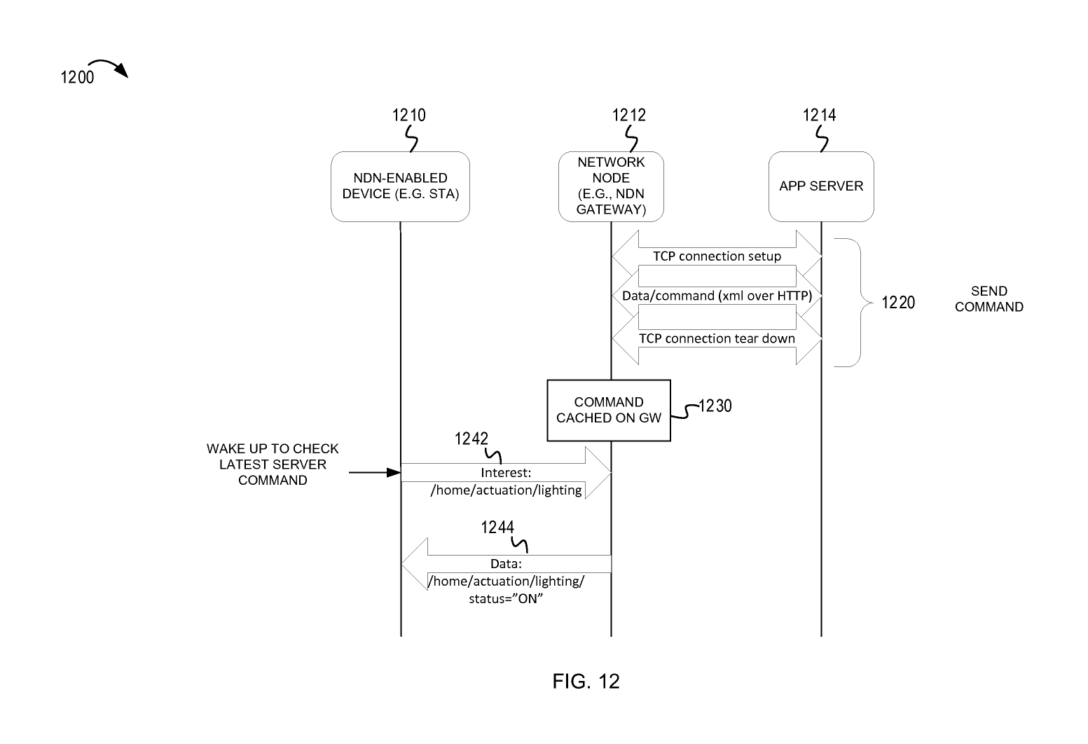

FIG. 12 depicts an example message flow 1200 with a control message in a mixed local area network. An NDN-enabled device 1210 is communicatively coupled to network node 1212 (e.g., NDN gateway). At 1220, an application server 1214 may utilize an IP-based communication protocol (e.g., TCP setup, data/command message, TCP tear down) to send one or more commands intended for the NDN-enabled device 1210. The network node 1212 intercepts the command and responds to the IP-based communication protocol with the application server 1214. However, in some embodiments, the NDN-enabled device 1210 may be configured to wake up periodically to check for commands. Therefore, the network node 1212 may cache 1230 the command in association with the corresponding named content.

The NDN-enabled device 1210 may wake up according to a periodic time interval and send an interest message 1242 to the network node 1212 to check for any pending commands. The network node 1212 may respond with an NDN-based message 1244 that includes the command from the cache corresponding to the command that the network node 1212 received from the application server 1214.

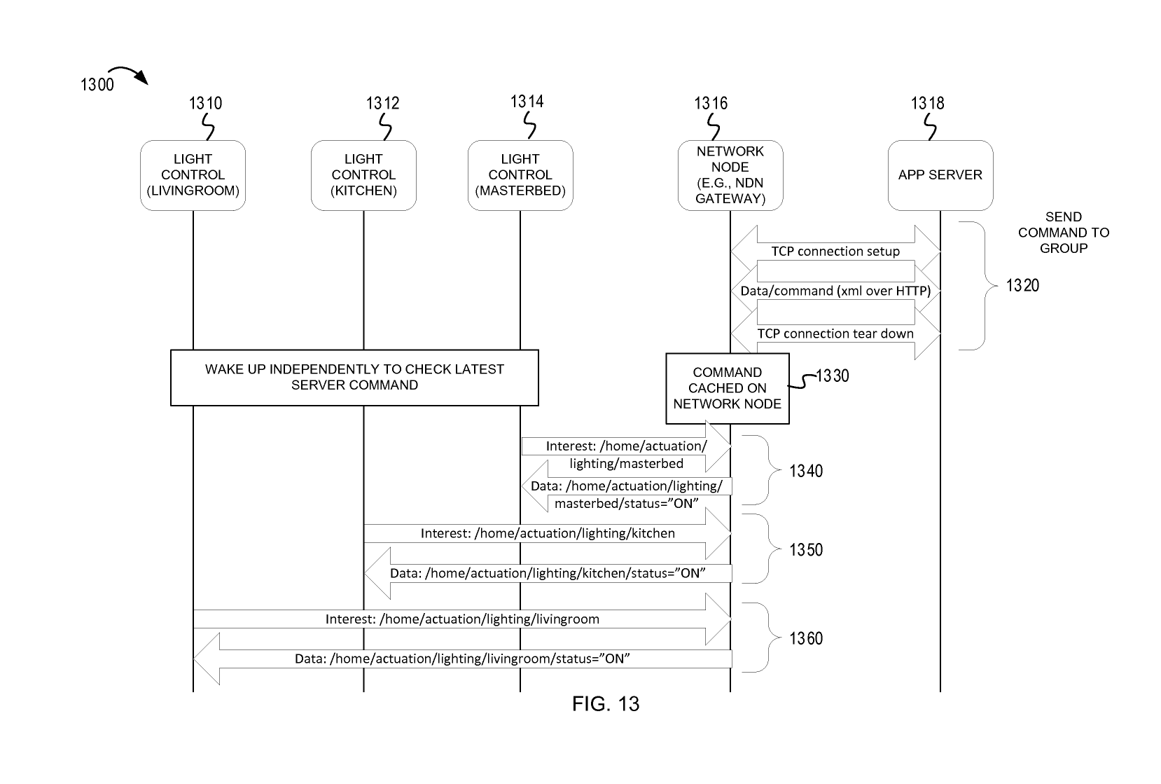

FIG. 13 depicts another example message flow 1300 with a control message in a mixed local area network. The example local area network includes light control 1310, 1312, 1314, corresponding to similar light controls 1110, 1112, 1114 described in FIG. 11. At 1320, an application server 1318 may send a command to the network node 1316 with instructions relevant to multiple NDN-enabled devices. For example, the command from the application server 1318 may indicate an instruction to turn on multiple lights associated with light controls 1110, 1112, 1114. At 1330, the network node 1316 may store the command in a cache. At 1340, the light control 1314 may wake up, check for commands cached at the network node 1316, and receive a command to activate the lighting in the masterbedroom light control 1314. For example, messages exchanged at 1340 may be similar to those described at 1242 and 1244 of FIG. 12. Similarly, at 1350 and 1360, the light control 1312 and light control 1310 may independently wake up, check for corresponding commands cached at the network node 1316, and receive a corresponding command to activate the lighting associated with each light control 1312, 1310. Each light control 1310, 1312, 1314 may independently wake up to check the latest server command.

In one embodiment of FIG. 13, the application server 1318 may utilize one command to activate multiple light controls based on an abbreviated name prefix that matches the desired light controls. Therefore, in one embodiment, the local area network naming convention provides for pseudo-multicast commands based on a coordinated naming scheme.

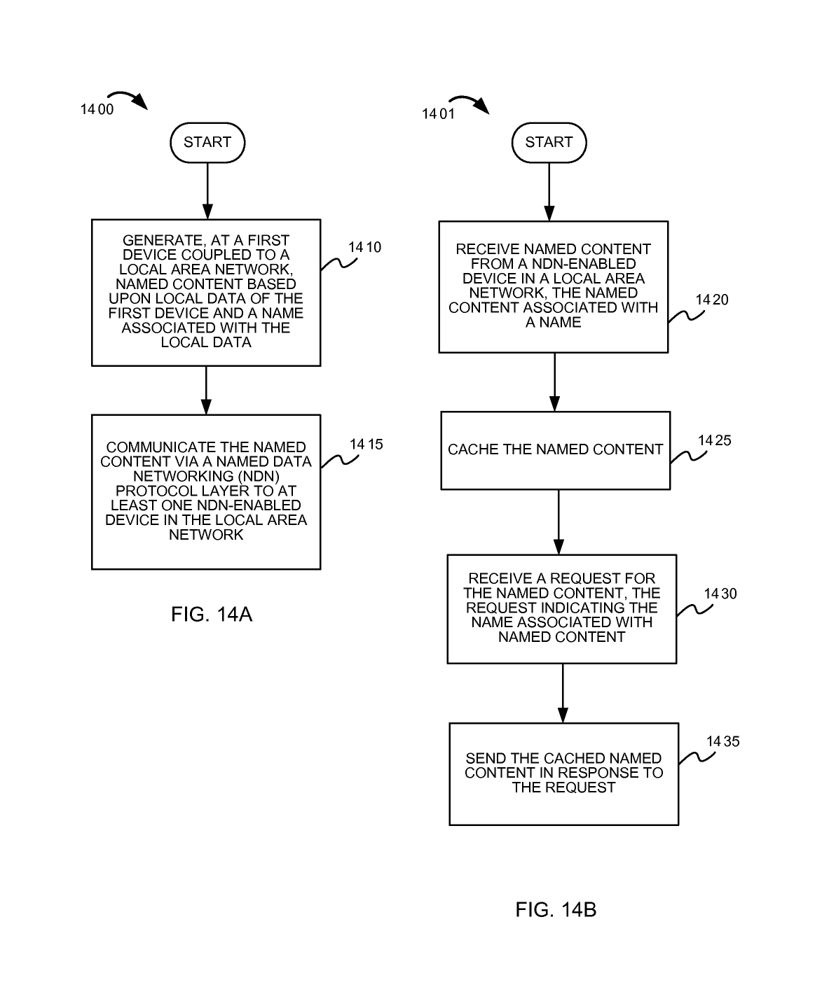

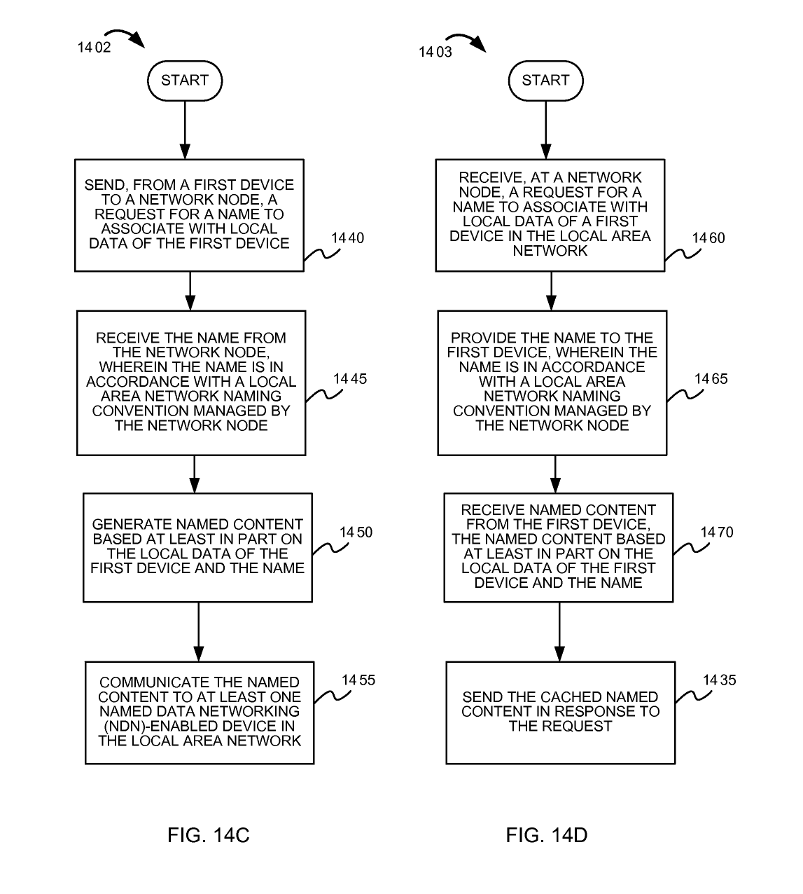

FIG. 14A depicts a flow diagram 1400 for an NDN-enabled device in accordance with at least one embodiment of this disclosure. At 1410, a first device may be coupled to a local area network and may generate named content based upon local data of the first device and a name associated with the local data. In some embodiments, the first device may announce (e.g., advertise) the existence of the named content by transmitted the name associated with the local data via the NDN-enabled local area network. At 1415, the first device may communicate the named content via a named data networking (NDN) protocol layer to at least one NDN-enabled device in the local area network.

FIG. 14B depicts a flow diagram 1401 for a network node in accordance with at least one embodiment of this disclosure. At 1420, the network node may receive named content from an NDN-enabled device in a local area network, the named content associated with a name. At 1425, the network node may cache the named content. At 1430, the network node may receive a request for the named content, the request indicating the name associated with named content. At 1435, the network node may send the cached named content in response to the request.

FIG. 14C depicts a flow diagram 1402 for a first device (e.g., NDN-enabled device) in accordance with at least one embodiment of this disclosure. At 1440, the first device may send, to a network node, a request for a name to associate with local data of the first device. At 1445, the first device may receive the name from the network node, wherein the name is in accordance with a local area network naming convention managed by the network node. At 1450, the first device may generate named content based at least in part on the local data of the first device and the name. At 1455, the first device may communicate the named content to at least one NDN-enabled device in the local area network.

FIG. 14D depicts a flow diagram 1403 for a network node in accordance with at least one embodiment of this disclosure. The network node may manage a local area network naming convention for named content in a local area network. At 1460, the network node may receive a request for a name to associate with local data of a first device in the local area network. At 1465, the network node may provide the name to the first device, wherein the name is in accordance with a local area network naming convention managed by the network node. At 1470, the network node may receive named content from the first device, the named content based at least in part on the local data of the first device and the name.

For example, an NDN-enabled device may determine the availability of named content by receiving an announcement including a name associated with the named content via an NDN-enabled local area network. The NDN-enabled device may request the named content from the NDN-enabled network by sending a request including the name.

FIGS. 1-14D and the operations described herein are examples meant to aid in understanding embodiments and should not be used to limit embodiments or limit scope of the claims. Embodiments may perform additional operations, fewer operations, operations in parallel or in a different order, and some operations differently.

As will be appreciated by one skilled in the art, aspects of the present subject matter may be embodied as a system, method, or computer program product. Accordingly, aspects of the present subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present subject matter are described with reference to flowchart illustrations and/or block diagrams of methods, apparatus (systems) and computer program products according to embodiments of the subject matter. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

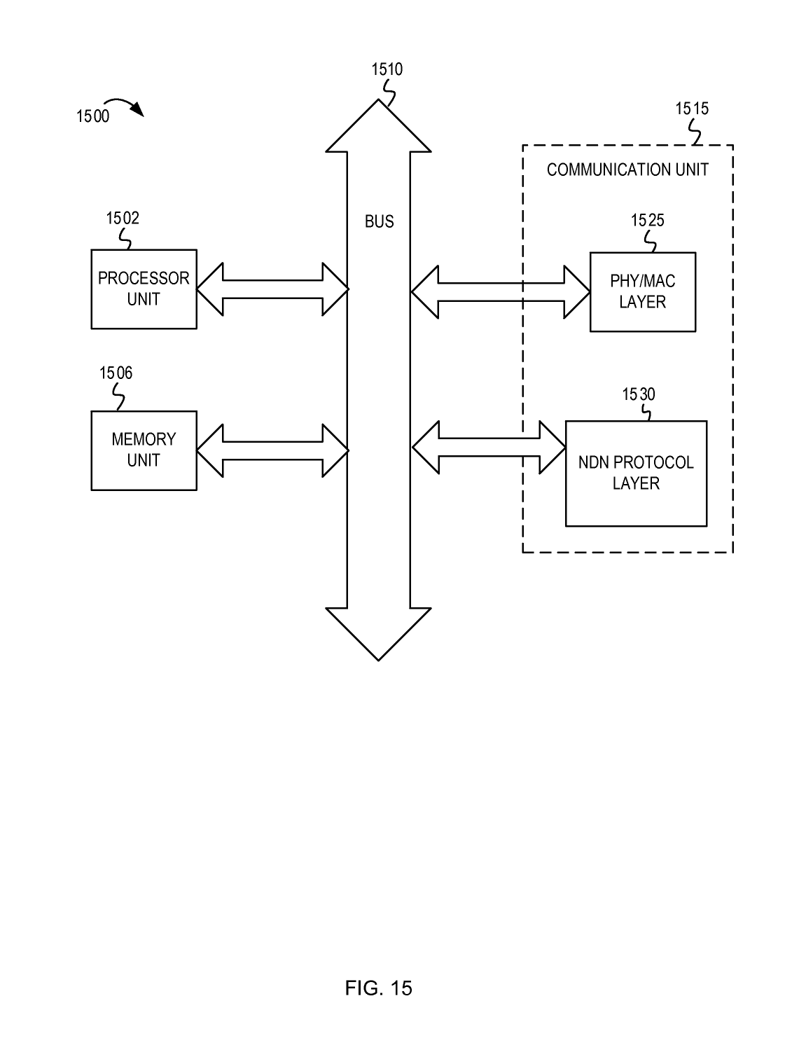

FIG. 15 is an example block diagram of one embodiment of NDN-enabled device 1500 including an NDN protocol layer 1530 in accordance with various embodiments of this disclosure. In some implementations, the NDN-enabled device 1500 may be one of a laptop computer, a netbook, a mobile phone, a powerline communication device, a personal digital assistant (PDA), or other electronic systems. The NDN-enabled device 1500 includes a processor unit 1502 (possibly including multiple processors, multiple cores, multiple nodes, and/or implementing multi-threading, etc.). The NDN-enabled device 1500 includes a memory unit 1506. The memory unit 1506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The NDN-enabled device 1500 also includes a bus 1510 (e.g., PCI, ISA, PCI-Express, HyperTransport®, InfiniBand®, NuBus, AHB, AXI, etc.), and may include other network interfaces (not shown) that may include at least one of a wireless network interface (e.g., a WLAN interface, a Bluetooth® interface, a WiMAX interface, a ZigBee® interface, a Wireless USB interface, etc.).

The NDN-enabled device 1500 may also include a communication unit 1515. The communication unit 1515 may comprise a PHY/MAC layer 1525 and the NDN protocol layer 1530. In some embodiments, the communication unit 1515 may also have a dedicated processor (e.g., such as a communication unit comprising a system on a chip, or board with multiple chips, or multiple boards, in which the communication may have one or more dedicated processor or processing unit(s), in addition to the processor unit 1502). In other embodiments, as described above in FIGS. 1-14D, the NDN protocol layer 1530 may implement functionality to communicate using NDN protocol messages with other NDN-enabled devices in a local area network. For example, the NDN protocol layer 1530 may implement functionality described as the NDN-enabled device or the various network nodes (NDN gateway or NDN bridge) in the previous descriptions. In some embodiments, the communication unit 1515 may be implemented entirely or partially as software executed by an operating system of a computer system. For example, the communication unit 1515 may be referred to as a driver (or drivers). Alternative, any one of these functionalities may be partially (or entirely) implemented in hardware and/or on the processor unit 1502. For example, the functionality may be implemented with an application specific integrated circuit, in logic implemented in the processor unit 1502, in a co-processor on a peripheral device or card, etc. Further, realizations may include fewer or additional components not illustrated in FIG. 15 (e.g., video cards, audio cards, additional network interfaces, peripheral devices, etc.). The processor unit 1502, the memory unit 1506, and the network interfaces 1504 are coupled to the bus 1510. Although illustrated as being coupled to the bus 1510, the memory unit 1506 may be coupled to the processor unit 1502.

While the embodiments are described with reference to various implementations and exploitations, it will be understood that these embodiments are illustrative and that the scope of the subject matter is not limited to them. In general, techniques for a named data networking protocol in a local area network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the subject matter.

What is claimed is:

1. A method for providing named content in a local area network, the method comprising:
sending, from a first device to a network node, a request for a name to associate with local data of the first device;
receiving the name from the network node, wherein the name is in accordance with a local area network naming convention managed by the network node;
generating named content based at least in part on the local data of the first device and the name; and
communicating the named content to at least one named data networking (NDN)-enabled device in the local area network.

2. The method of claim 1, wherein said communicating the named content includes communicating the named content via a NDN protocol layer of the first device.

3. The method of claim 1, further comprising:
detecting a change to the local data;
generating an updated named content based, at least in part, upon the local data after detecting the change to the local data; and
communicating the updated named content to the at least one NDN-enabled device.

4. The method of claim 3, further comprising:
determining an updated name for the updated named content after detecting the change to the local data, wherein the updated name is based at least in part on the name received from the network node.

5. The method of claim 4, wherein the updated name associated with the updated named content shares a common prefix as the name received from the network node.

6. The method of claim 3, wherein said communicating the updated named content includes communicating the updated named content regardless of whether the first device has received a request for the updated named content.

7. The method of claim 1, wherein said communicating the named content includes communicating the named content in accordance to a configured schedule.

8. The method of claim 1, further comprising:
receiving a command from the NDN-enabled device, the command including the name associated with the named content and including an instruction.

9. The method of claim 8, further comprising:
causing a change to a controller or actuator in accordance with the instruction included in the command from the NDN-enabled device.

10. The method of claim 1, further comprising:
entering a sleep mode of a communication unit of the first device at a time when the first device is not communicating the named content, the sleep mode associated with disabling network communication to conserve power.

11. A first device, comprising:
a physical network interface for coupling to a local area network; and
a named data networking (NDN) protocol layer configured to:
send, to a network node, a request for a name to associate with local data of the first device;
receive the name from the network node, wherein the name is in accordance with a local area network naming convention managed by the network node;
generate named content based at least in part on the local data of the first device and the name; and
communicate the named content to at least one named data networking (NDN)-enabled device in the local area network.

12. The first device of claim 11, wherein the first device is a battery powered device.

13. The first device of claim 11, further comprising:
a controller or actuator capable of modifying an output associated with the first device, the controller or actuator responsive to a command received by the NDN protocol layer via the local area network.

14. A method for managing a local area network naming convention for named content in a local area network, the method comprising:
receiving, at a network node, a request for a name to associate with local data of a first device in the local area network;
providing the name to the first device, wherein the name is in accordance with a local area network naming convention managed by the network node; and
receiving named content from the first device, the named content based at least in part on the local data of the first device and the name.

15. The method of claim 14, further comprising:
caching the named content;
receiving a request for the named content, the request indicating the name; and
sending the cached named content responsive to receiving the request.

16. The method of claim 14, further comprising:
mapping the named content to an ingress interface of the network node.

17. The method of claim 16, wherein the ingress interface of the network node is associated with a first segment of the local area network, the method further comprising:
bridging the named content from the first segment of the local area network to a second segment of the local area network.

18. The method of claim 14, further comprising:
providing remote access for a wide area network to access the named content located in the local area network.

19. The method of claim 18, wherein the name comprises a first name associated with the named content in accordance with a local area network naming convention, the method further comprising:
associating a second name with the named content, wherein the second name is used in accordance with a public network naming convention.

20. The method of claim 14, further comprising:
receiving a plurality of named content from a plurality of devices, the plurality of named content having corresponding names that share at least a common portion;
receiving a request from an NDN-enabled device, the request indicating the common portion associated with the plurality of named content; and
aggregating the plurality of named content into a single response to the request.
